(19) United States
(12) Patent Application Publication
(10) Pub. No.: US 2012/0135119 A1
(43) Pub. Date: May 31, 2012

(54) BREWING PROCESS

(75) Inventors: Jochen Gussmann, Schwaebisch-Gmuend (DE); Wolfgang Scheible, Ettlenschiess (DE)

(73) Assignee: WMF Wuerttembergische Metallwarenfabrik AG, Geislingen/Steige (DE)

(21) Appl. No.: 13/307,026

(22) Filed: Nov. 30, 2011

(30) Foreign Application Priority Data
Nov. 30, 2010 (DE) 10 2010 062 180.3

(51) Int. Cl. A23F 5/08; A23F 5/26; A47J 31/42

(52) U.S. Cl. 426/433; 99/280

(57) ABSTRACT

The invention relates to a method for brewing coffee in a coffee machine, particularly an automatic or fully automated espresso machine, wherein coffee beans are ground to coffee powder of a predefined quantity of coffee powder and/or a predefined grinding degree by a grinding device of the coffee machine, during a press process, the coffee powder is pressed in a brewing chamber of the coffee machine at a predefined press force, during the brewing process, a predefined quantity of water, heated to a predefined brewing temperature is passed through the coffee powder and an actual brewing time is determined, the actual brewing time is compared to a saved target brewing time, the actual brewing time is adapted to the target brewing time by increasing/reducing the press force during the brewing process or before every new coffee brewing. Thus, the brewing time can be controlled by the press force.

### BACKGROUND OF THE INVENTION

1. Field of the Invention

The invention relates to a method for brewing coffee in a coffee machine. Furthermore, the invention relates to a coffee machine operating according to this brewing process.

2. Description of the Related Art

Currently, coffee machines, particularly for use in restaurants, are delivered with pre-set coffee grinders, wherein the pre-setting of the coffee grinders corresponds to an average grinding degree, determined with a coffee bean that, as experience teaches, is frequently used. During installation or adjustment of the coffee machine, the grinding degree of the coffee grinders is then adapted to the beans used respectively. In order to do that, the ejection performance of the grinders can be calculated and compared to the recipes saved in the coffee machine. It is already possible today to set such an optimization for the recipes of different coffee brew drinks separately respectively. For operating the coffee machine, the user has regarding the different recipes further parameters at his disposal to set the quality of the coffee brew drink, for instance a quantity of powder, a quantity of water, a brewing temperature and the type of coffee powder pre-processing. However, usually it is renounced to modifying the grinding degree during continuing operation. The coffee powder pre-processing can be offered on several quality levels, wherein, according to the quality level, certain parameters are pre-set on predefined values. Such parameters for setting the quality levels of the coffee powder pre-processing can for instance be a swelling volume, a preinfusion, different process times, the pre-charge pressure and the pre-charge time.

However, in these conventional coffee machines that are currently standard, the phased setting of the parameters in the predefined values according to selectable quality levels is detrimental. Furthermore, these predefined values are determined with certain coffee beans. If other beans are used, the different quality levels can differ considerably from one another despite an optimal setting of the grinding degree. This can result in a big change of the brewing time, and as the brewing time influences for instance the quality of the coffee brew drink, in an according change of quality of the coffee. Furthermore, the coffee grinder integrated into the coffee machine is also exposed to a certain wear, which can lead to a change in the grinding degree in the course of the using time. Due to this change of the grinding degree caused by wear, fluctuations in the target quality of the coffee brew drink can also occur, as well as for instance when changing the type of coffee beans used.

### SUMMARY OF THE INVENTION

The present invention deals with the problem of indicating an improved or at least alternative embodiment for a coffee machine and a related brewing process, characterized particularly by having fewer fluctuations in the desired quality of the coffee.

According to the invention, this problem is solved by the subject matter of the independent claims. Favorable embodiments are subject matter of the dependent claims.

The invention is based on the general idea of adapting an actual brewing time via a (wet) press force to a target brewing time. In the invention-based method for brewing coffee in a coffee machine, particularly in an automatic or fully automated espresso machine, during a grinding process, coffee beans are ground through a grinding installation of the coffee machine to coffee powder of a predefined quantity of coffee powder and/or a predefined grinding degree, and during a pressing process, the coffee powder in the coffee machine is pressed at a certain pressure, i.e. at a predefined press force. During the brewing process, a predefined quantity of water, heated to a predefined brewing temperature is also led through the coffee powder and an actual brewing time is determined, wherein the actual brewing time is compared to a saved target brewing time and adapted to the target brewing time by increasing/reducing the press force during the brewing process or before every new brewing of coffee. Because of the adaption of the press force before every press process, the brewing time and thus the contact time of the brewing water with the coffee powder can be adapted. As the brewing time is an important parameter for the quality of the coffee brew drink, before every brewing of the coffee powder, the quality of the coffee brew drink can thus be optimized and the fluctuations in the respective target quality of the coffee brew drink can be reduced. A coffee brew drink means a brew drink produced by brewing ground coffee powder made from coffee beans. It is thus produced such a coffee brew drink according to the invention in a coffee machine comprising a coffee grinder grinding the coffee beans to coffee powder and in which hot water is pressed through the finely ground coffee powder under a predefined pressure. Usually, a thus prepared coffee brew drink can be called espresso. Thus, in the case of the espresso, the water temperature usually is ca. 87±7° C. and the pressure with which the hot water is pressed through the coffee powder is ca. 9±3 bar. During the coffee brewing process, during which hot water is pressed at a high pressure through very finely ground coffee powder, a concentrated coffee brew drink is prepared, on which a thick, hazelnut colored foam layer, the so called crema, forms, contributing considerably to the aroma and the quality of the coffee brew drink.

According to the invention, a coffee brew drink in a coffee machine is thus produced in the following steps or processes:

In a grinding process, coffee beans stored in the coffee machine are ground to coffee powder at a predetermined grinding degree and in a predetermined quantity of coffee powder. During the coffee powder pre-processing, a preinfusion from water to coffee powder can be executed, making the coffee powder swell. During a press process, the optionally pre-wetted coffee powder is pressed at a predefined press force and a predefined press time to a press cake. In the following brewing process, a predefined quantity of water, heated to a predefined water temperature, is pressed through this press cake made of pressed coffee powder, wherein the brewing time corresponds to the contact time of the hot water with the pressed coffee powder. Before preparing the coffee, usually certain parameters can be defined on the coffee machine by selecting a formula. Such parameters are for example a grinding degree, a quantity of coffee powder, a quantity of water, a brewing time, a water flow, a pressure, a press force, a brewing temperature, a coffee powder volume, a quantity of water to pre-wet the coffee powder and/or a swell volume. Due to these predefined parameters, the accordingly desired quality of the coffee brew drink is reached. Thus, particularly the brewing time, i.e. the contact time of the hot water and coffee powder, is a decisive factor for the quality of the coffee brew drink.

However, because of fluctuations in the above mentioned parameters, there can be a fluctuation of the brewing time and an according fluctuation of the quality of the coffee brew drink. It is thus imaginable that for instance over time, the coffee grinder only produces an insufficient grinding degree due to wear. There can also be fluctuations in the grinding degree when different coffee beans are used. It must also be expected that there will always be a certain distribution in the quantity of coffee powder produced by the coffee grinder, as the dosage of the beans naturally entails a fluctuation of the quantity of coffee powder. Thus, a certain, non-desired fluctuation of the brewing time is to be expected.

By using the invention, it is however possible to control the set and target brewing time respectively via the pressure/press force with which the coffee powder is pressed during the press process and before the brewing process. Thus, the bigger the brewing time, the finer the grinding degree and the higher the pressure/press force. Thus, by setting the press force during the press process, the brewing time can be set during the brewing process and in particular be adapted to predefined optimal values.

By comparing the actual brewing time to the target brewing time, it is possible to draw conclusions as to how the press force of the current press process has to be selected so that the brewing time of the actual brewing process shows the target value. Thus, fluctuations of the quantity of the coffee powder, of the grinding degree and of the used coffee beans can be compensated. If the actual brewing time was too short, compared to a target brewing time, the press force and thus the pressure of the current press process are increased. If however for instance the brewing time of an anterior brewing process was too long, the press force of the current press process is reduced. The press force accordingly adapted can then be saved for the target brewing time regarding the respective recipe. Thus, the brewing time regarding the respective specific recipe can be controlled and, in case of deviation, be accordingly adapted by changing the press force.

Thus, in operation, the brewing times for the respective recipes can be controlled and compared to the target values set for each recipe. In case of deviation from the respective aims, by using such a loop, the press force can be adjusted and generally constant brewing times can be achieved.

Besides, it is possible to measure the coffee powder volume if necessary by a dry pressing after the grinding process and before the press process or before the preinfusion and to on the one hand draw conclusions regarding the quality of the coffee grinder and on the other hand to take into account the identified coffee powder volume when setting the press force. Thus, fluctuations of the quantity of coffee powder produced by the coffee grinder and if necessary a fluctuation of the grinding degree can at least be partially compensated.

Furthermore, the brewing time also depends on the temperature state of the coffee machine. The longer the break since the last brewing process, the stronger the cooling of the coffee machine and the shorter the brewing time of another brewing process. In order to compensate this loss of quality, the press force can be increased depending on the pausing time. Thus, the time between the pauses between the individual brewing processes can be taken into account as well.

All these fluctuations that can be compensated by the pressure or the press force thus do not require any change of formula, so that the quality of the coffee brew drink is not, as it is common today, adjusted afterwards by adapting the formula.

It is possible that the brewing time of a current brewing process does not reach the desired target in spite of an adjustment of the press force. In this case, conclusions can be drawn regarding the grinding performance or the grinding degree of the coffee grinder. Accordingly, the coffee machine can autonomously adapt the grinding degree and/or the quantity of coffee powder. This is preferably executed when, based on the comparison of a brewing time-pressure value pair of a current brewing process with a brewing time-pressure value pair from a map and/or with a brewing time/pressure value pair of at least one preceding brewing process, a predefined deviation limit is reached and/or exceeded. If the brewing time then clearly is too short, the quantity of powder can be adjusted to be bigger or the grinding degree to be finer. If the brewing time clearly is too long, the quantity of powder can be determined to be smaller or the grinding degree to be more coarse.

This automated control of the grinding degree or the quantity of powder can be applied during commissioning of the coffee machine as well as during adjustment. Therefore, by making at least one experimental preparation, the brewing time is, at an accordingly set grinding degree and/or a quantity of coffee powder and/or press force, calculated automatically, compared to a target value of the brewing time and the grinding degree and/or the quantity of powder and/or the press force for a future brewing time are adjusted. Thus, the commissioning is clearly simplified and necessary adjustments are executed automatically by the coffee machine.

Furthermore, in this case it is possible to offer the coffee brew drink on different quality levels. For instance, it is thus possible to economically produce a rapid espresso with a short brewing time, whereas with a long brewing time, a slow espresso of the highest quality can be produced. Therefore, several quality levels are also imaginable between a rapid and a slow espresso.

The different, above mentioned parameters can be recorded by sensors and the actual and the target values can be compared. This information can be saved and if there is an according quality deviation, it can be issued or the errors can be issued.

Furthermore, such a monitoring of parameters allows drawing conclusions regarding the state of the grinder. Thus, from the measured and compared parameters for instance a conclusion regarding the grinding performance, the grinding degree and thus regarding the grinding quality of the coffee grinder can be drawn. Therefore, when an accordingly recorded grinding quality is reached, a repair or maintenance service can be requested or such information can be issued to the user.

To execute the necessary comparisons between the target and actual values, the coffee machine is preferably equipped with a control, steering and operating device comprising a programmable, logical circuit, for instance a microcontroller or processor for data processing and control/steering and/or at least a memory device to save programs, device parameters, program parameters and/or historical information and/or a data interface device for exchanging information and/or a device for issuing information to a user and/or an input unit for operating the control, steering and operation device and/or an electrical energy storage.

Other important characteristics and advantages of the invention result from depending claims, from the drawings and from the relevant descriptions of the figures in accordance with the drawings.

It goes without saying that the above mentioned and the still to be explained characteristics are not only applicable in the respectively indicated combination, but also in other combinations or separately without leaving the frame of the present invention.

Preferred examples of embodiments of the invention are presented in the drawings and are further explained in the following description, wherein identical references refer to identical or similar or functionally identical components.

### BRIEF DESCRIPTION OF THE DRAWINGS

FIG. 1 a brewing time-press force diagram for different degrees of grinding.

FIG. 2 a press force-brewing flow diagram for different quantities of coffee powder.

FIG. 3 is a schematic illustration of a coffee machine in accordance with the invention.

### DETAILED DESCRIPTION OF THE PREFERRED EMBODIMENTS

In the brewing time-press force diagram 1 as shown in FIG. 1, the brewing time is indicated on the ordinate 2, whereas on the X-axis 3, the press force is indicated. In the diagram, three brewing time-press force curves 4, 4′, 4″ are shown for a fine grinding degree 4, a medium grinding degree 4′ and a coarse grinding degree 4″. It is thus shown in the brewing time-press force diagram 1 that the brewing time increases if the press force increases. Furthermore, at constant press force and increasing grinding degree, the brewing time increases as well.

Therefore, by setting the grinding degree and/or by setting the press force, the brewing time can be set to the according target value.

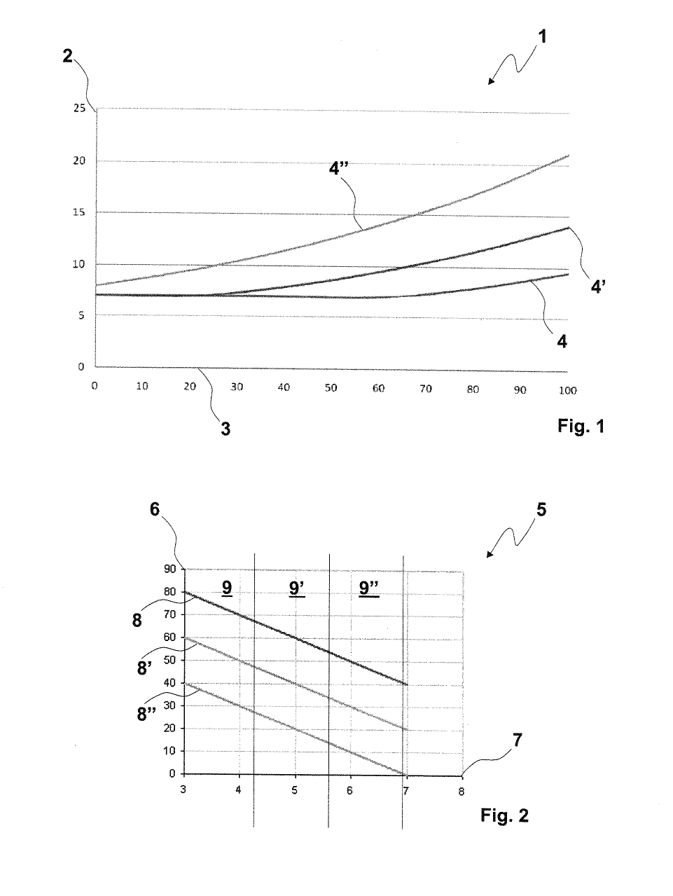

The press force—water flow diagram displayed in FIG. 2 shows the dependence of the press force from the water flow and from the quantity of coffee powder. On the ordinate 6, the press force is indicated and on the X-axis 7 the water flow is indicated. In the press force-water flow diagram 5, three press force-water flow curves 8, 8′, 8″ are drawn. The curve of the 8 g-curve 8, of the 12 g-curve 8′ and the 14 g-curve 8″ shows that if having a correspondingly defined and desired water flow and an increasing quantity of coffee powder (8 g, 12 g, 14 g), the press force can be reduced.

Now the water flow can be divided into different ranges of quality 9, 9′, 9″ of the coffee brew drink. The higher the water flow, the lower the quality that can be expected of the coffee brew drink. Thus, the quality range 9 represents a high quality, the quality range 9′ represents a medium quality and the quality range 9″ a low quality and a high productivity of the coffee machine.

Therefore, the quality of the coffee brew drink can be set by adapting the quantity of coffee powder and/or the press force.

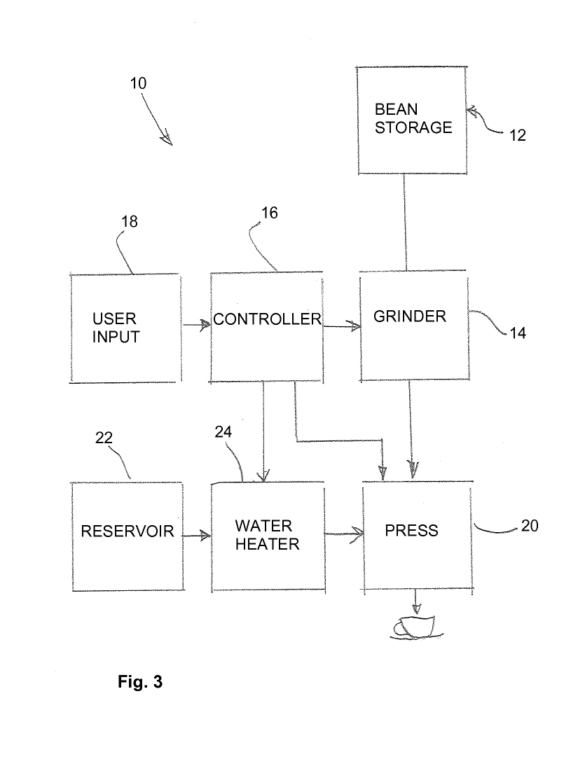

A coffee machine in accordance with the invention is identified generally by the numeral 10 in FIG. 3. The coffee machine 10 includes a coffee bean storage 12 for storing coffee beans. Although a single coffee bean storage 12 is illustrated, the coffee machine 10 may include a plurality of such bean storages for storing different types of coffee. A grinder 14 communicates with the coffee bean storage 12 and can receive a controlled amount of coffee beans from the bean storage 12. The grinder 14 is adjustable to achieve a selected volume of ground coffee with a desired granular size. A control unit 16 controls the operation of the grinder 14 based on user input provided at an input device 18, such as a control panel. A coffee press 20 is in communication with the grinder 14 to receive the ground coffee from the grinder 14. The press 20 is adjustable to control the amount of pressure applied to the ground coffee, and the particular pressure applied during a brewing process is controlled by the controller 16 based on user input received from the input device 18. The coffee machine 10 further includes a water reservoir 22 for storing a supply of water that will be used in the coffee brewing process. A water heater 24 communicates with the water reservoir 22 and is operative for delivering a controlled quantity of water to the press 20 at a selected temperature. The temperature and volume of water delivered from the reservoir 22 and heater 24 to the press 20 are controlled by the controller 16 based on user input provided at the input device 18.

What is claimed is:

1. A method for brewing coffee in a coffee machine, comprising
grinding coffee beans in the coffee machine to coffee powder of a predefined quantity or a predefined grinding degree;
pressing the coffee powder in a brewing chamber of the coffee machine at a predefined press force;
heating a predefined quantity of water to a predefined brewing temperature, leading the water through the coffee powder and determining an actual brewing time;
comparing the actual brewing time to a saved target brewing time;
adapting the actual brewing time to the target brewing time by increasing/reducing the press force during the brewing process or before every new brewing of coffee.

2. The method of claim 1, further comprising wetting the coffee powder with a predefined quantity of water before pressing the coffee powder.

3. The method of claim 1, further comprising determining at least one of a grinding degree, a quantity of coffee powder, a quantity of water, a brewing time, a water flow, a press force and a brewing temperature before preparing the coffee.

4. The method of claim 1, further comprising:
adapting the press force to the quantity of ground coffee powder due to an identified volume of coffee powder or due to at least one time interval of at least one preceding brewing, or
adapting the press force to the quantity of ground coffee powder based on an average coffee powder volume identified by means of preceding brewing processes.

5. The method according to claim 4, identifying the volume or quantity of the coffee powder by a pre-charge before wetting

6. The method of claim 1, further comprising adapting the grinding degree or the quantity of powder based on the comparison of an actual brewing time-press force value pair of a current brewing process with a target brewing time-press force value pair from a map or a brewing time-press force value pair of at least one preceding brewing process.

7. The method of claim 1, adapting the grinding degree, the quantity of powder or the press force during commissioning and/or adjustment and thus setting the brewing time via at least one sample preparation.

8. A coffee machine operated according to the method of claim 1, comprising a control, steering and operation device that adapts a brewing time by modifying a press force at which the coffee powder in the coffee machine is pressed.

9. The coffee machine of claim 8,
characterized in that
the control, steering and operation device comprises at least one component from the following group; a programmable, logical circuit, p. e. a microcontroller or processor for data processing and control/steering, at least one data memory to save programs, device parameters, program parameters and/or historical information, a data interface device for exchanging information, a device for issuing information to a user, an input device for operating the control, steering and operation device, an electric energy storage at least for emergency power supply.
